(19) United States
(12) Patent Application Publication
(10) Pub. No.: US 2009/0101065 A1
(43) Pub. Date: Apr. 23, 2009

(54) Apparatus for the flocking of articles, in particular of textile materials

(76) Inventor: Markus Walz, Lichtenstein (DE)

Correspondence Address: KRIEGSMAN & KRIEGSMAN, 30 TURNPIKE ROAD, SUITE 9, SOUTHBOROUGH, MA, 01772, US

(21) Appl. No.: 12/283,301

(22) Filed: Sep. 10, 2008

(30) Foreign Application Priority Data
Sep. 11, 2007 (DE) 20 2007 012 699.9
Sep. 12, 2007 (DE) 20 2007 012 745.6

(51) Int. Cl. B05B 13/02

(52) U.S. Cl. 118/319

(57) ABSTRACT

Apparatus for the flocking of articles, with a central column which has a rotary drive rotating about a vertical axis, with a least one pallet carrier arranged on the central column and having in each case a pallet, arranged on the pallet carrier, for receiving an article to be flocked, with at least one frame carrier, arranged above the pallets revolving around the vertical axis, for receiving a flocking device, the frame carrier and a frame arranged on it and also the pallet being arranged so as to be moveable in the vertical direction in relation to one another, and the pallet carrier on the central column assuming a plurality of rotary positions predetermined in steps along a circular path with respect to the frame, characterized in that a mechanical actuating device is provided, which lifts off the flocking device at least partially from the frame, so that a stencil arranged on the frame is accessible.

### BACKGROUND OF THE INVENTION

The invention relates to an apparatus for the flocking of articles, in particular of textile materials, mats, ceramics, plastics, paper, wood, metal or the like.

In the coating industry, in particular the flock industry, various plants are already in use which make it possible to apply flock material to an adhesive-wetted surface of an article. Preferably short fibres, in particular textile fibres, are employed as flock material. By means of an electrostatic charging of fibres received in a container, the flock material is expelled and applied to the article to be flocked. In particularly DE 196 22 230 A1 discloses a flocking apparatus consisting of a plurality of planting units which are assigned in each case to a pallet arranged on a pallet carrier. The pallet carriers are provided on a rotary drive which transports the article arranged on the pallet from processing station to processing station. Above the pallet, in addition to a plurality of printing units, a processing station with a flocking container is provided, which applies textile fibres to the article. The flocking apparatus provided for this purpose is also used for the manual flocking. In such apparatuses, only single-colour flocking is carried out.

Owing to modernization and the increase in flexibility for the production of flocking designs, there is now the requirement that different colours and fibre lengths and/or different flock materials have to be used and processed. For this purpose, it is necessary for a plurality of processing stations to be provided in succession. In each processing station, a flocking apparatus is provided which applies a predetermined part of a flocking design to the article. For each part of the flocking design, a stencil is provided in a stencil frame which is to be aligned with the pallet assigned to the flocking apparatus. On the stencil, at least one setting mark is provided which, in order to apply part-designs, is congruent in all the stencils when these are laid one above the other. As a result, the flocking designs to be applied successively are aligned so as to be directly contiguous to one another. For this purpose, an exact setting of the stencil frames having the respective flocking design is required. This makes it necessary to remove the flocking apparatus from the processing station and return it again several times, in order to make it possible to set the stencil frame after the removal of the flocking apparatus from the processing station. The handling of the flocking apparatus, because of its weight, is scarcely possible for an operator alone and requires additional assistance. Furthermore, such manual handling is time-consuming and inefficient.

### SUMMARY OF THE INVENTION

The object on which the invention is based, therefore, is to provide an apparatus for the flocking of articles, in particular textile materials, which allows a rapid and exact setting of stencil frames in the case of the flocking design which involves one or more flocking operations.

This object is achieved, according to the invention, by means of the features of claim 1. Further advantageous refinements and developments are specified in the further claims.

The apparatus according to the invention makes it possible to have simple and rapid access to a stencil frame having a flocking design, in that the flocking device is lifted off at least partially upwards with respect to the stencil frame. For this purpose, an actuating device is provided which can be activated mechanically and thus makes it possible at least partially to lift off the flocking device with respect to a frame to which the stencil frame is fastened. This affords the operating personnel, without physical effort, with rapid access to the stencil frame, in order to align the latter for a flocking design exactly with a setting mark of a preceding stencil frame.

According to a preferred refinement of the invention, there is provision for the flocking device to be mounted pivotably about an axis of rotation which is arranged between the vertical axis of the central column and an outer frame portion of the frame carrier, so that the flocking device can be lifted off upwards to a frame portion which is outer radially to the axis of rotation. As a result, by means of a simple pivoting movement about the axis of rotation, a lift-off of the flocking device can be provided, so that good access is provided for setting the stencil frame which is fastened to the frame held by the frame carrier. Good access from outside is thereby made possible, so that the user is enabled to set the stencil frame outside the circular path formed by the rotary position of the pallet carriers, in that, after the flocking device has been lifted off, a simple inspection from outside and from above is made possible.

According to a first alternative embodiment of the apparatus, there is provision for the flocking device to be arranged pivotably about an axis of rotation provided on the frame and for the axis of rotation preferably to be oriented tangentially to the circular path, so that the flocking device can be lifted off upwards in the direction of the vertical axis. This, in turn, makes it possible that the stencil frame can be observed outside a working range of the apparatus for the flocking of articles. This direct tie-up of the flocking device via an axis of rotation on the frame makes it possible to have a structurally simple and weight-saving arrangement.

According to an alternative embodiment of the invention, there is provision for there to be provided on the frame or frame carrier a carrying arm which is pivotable about an axis of rotation and on which the flocking device is arranged and which is pivotable upwards about this axis of rotation, so that the stencil frame is easily accessible outside the working range of the pallet. The carrying arm is preferably arranged on a radially inner frame portion or frame carrier, so that the flocking device is lifted off with respect to the radially outer frame portion.

According to a preferred refinement of the alternative embodiment, the flocking device is provided releasably with respect to the carrying arm. A simple change of the flocking device on the carrying arm is thereby made possible, so that the flocking apparatus can be converted quickly to a new flocking design, in that, for example, a further flocking device with a differently coloured flock material or with another type of flock material and/or another fibre length can be fastened to the carrying arm.

According to a further preferred refinement of the invention, there is provision for the actuating device to comprise at least one working cylinder which acts, with respect to the axis of rotation about which the flocking device is pivotable, on the radially outer region of the flocking device or the carrying arm carrying the flocking device and which, on the opposite side, can be fastened to an articulation apparatus which is arranged on a lifting pillar of the central column. The advantage of this arrangement is that the previous construction of the apparatus for the flocking of articles can be preserved and, optionally, an additional mounting of an automatic or mechanically activatable actuating device for the simple lift-off of the flocking device with respect to the stencil frame is made possible. Alternatively to the working cylinder, further motor-activatable arrangements may be provided which allow a shortening of the distance between the articulation apparatus and a point of action on the flocking device or the carrying arm. For example, a rope winch or a chain drive may be provided. Furthermore, electromotive drives, rack drives or the like may also be used.

According to a further preferred refinement of the invention, there is provision for the articulation apparatus to have a ring arranged concentrically to the vertical axis and having a plurality of mounting plates to which a working cylinder can be fastened. The articulation apparatus is preferably carried by a lifting pillar of the central column. This articulation apparatus can be attached in a simple way in order to receive the working cylinder so that an actuating device is formed.

This articulation apparatus preferably comprises a mounting plate for each processing station, so that one or more flocking stations can be equipped with the actuating device as a function of the equipment requirements of the flocking machine.

According to a further advantageous refinement of the invention, there is provision for the carrying arm receiving the flocking device or the flocking device arranged pivotably on the frame to be pivotable out of the working position through at least 15°. This makes it possible to inspect the stencil frame from a region outside the working range of the pallet carrier. Furthermore, a visual check of the lower outlet side of the flocking device can become possible.

According to an alternative embodiment of the actuating device for at least partially lifting off the flocking device, there is provision for at least one working cylinder to act on the frame and with its opposite end to act on the flocking device or the carrying arm, in order to lift off the latter upwards. In this case, the carrying arm or the actuating device is pivoted about an axis of rotation which lies between a radially outer frame portion and the vertical axis of the central column and which is preferably formed on an inner frame portion of the frame which, in particular, is adjacent to the frame carrier.

The at least one working cylinder arranged on the frame acts preferably on a lever or lever mechanism which is arranged between the frame and the flocking device or the carrying arm receiving the flocking device. Additional lever assistance can thereby become possible, in order with low forces to allow an at least partially upward-directed lift-off of the flocking device.

According to a further advantageous refinement of the actuating device, at least two lifting cylinders arranged on the frame are provided, which lift off the flocking device with respect to the frame and hold the flocking device oriented parallel to the latter. For example, two lifting cylinders lying opposite one another may act on the frame, on the one hand, and on the flocking device, on the other hand, and carry out a raising and lowering movement.

According to a further advantageous refinement of the actuating device with at least two lifting cylinders, there is provision, additionally, for at least one guide to be provided, in order to avoid a tilting of the flocking device when only two lifting cylinders are used. Preferably, four lifting cylinders are provided, so that a parallel raising and lowering with respect to the stencil frame are made possible in each corner region or near each corner region.

According to a further advantageous refinement of the actuating device which comprises at least two lifting cylinders arranged on the frame, there is provision for the lifting cylinders to be telescopic. Thus, if the set-up height is low, a high lift-out height becomes possible, in order to achieve good access to the stencil frame.

### BRIEF DESCRIPTION OF THE DRAWINGS

Further advantageous refinements and developments are specified in the further claims. In the drawing:

FIG. 1 shows a diagrammatic side view of a processing station of an apparatus for the flocking of articles,

FIG. 2 shows a diagrammatic view of the processing station according to FIG. 1 from the front,

FIG. 3 shows a diagrammatic view of the processing station according to FIG. 1 from above,

FIG. 4 shows a diagrammatic view of the processing station according to FIG. 1 in which the flocking device has assumed a setting position,

FIG. 5 shows a diagrammatic sectional illustration of the processing station according to FIG. 1,

FIG. 6 shows a diagrammatic side view of an alternative actuating device, and

FIG. 7 shows a diagrammatic side view of a further alternative actuating device.

### DETAILED DESCRIPTION OF THE INVENTION

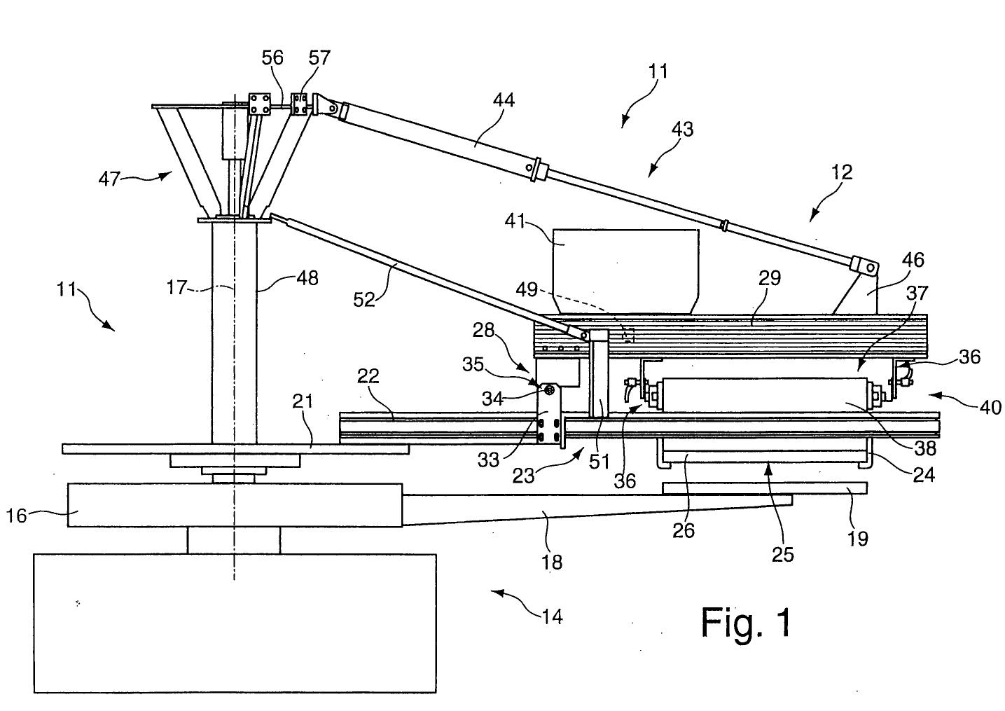

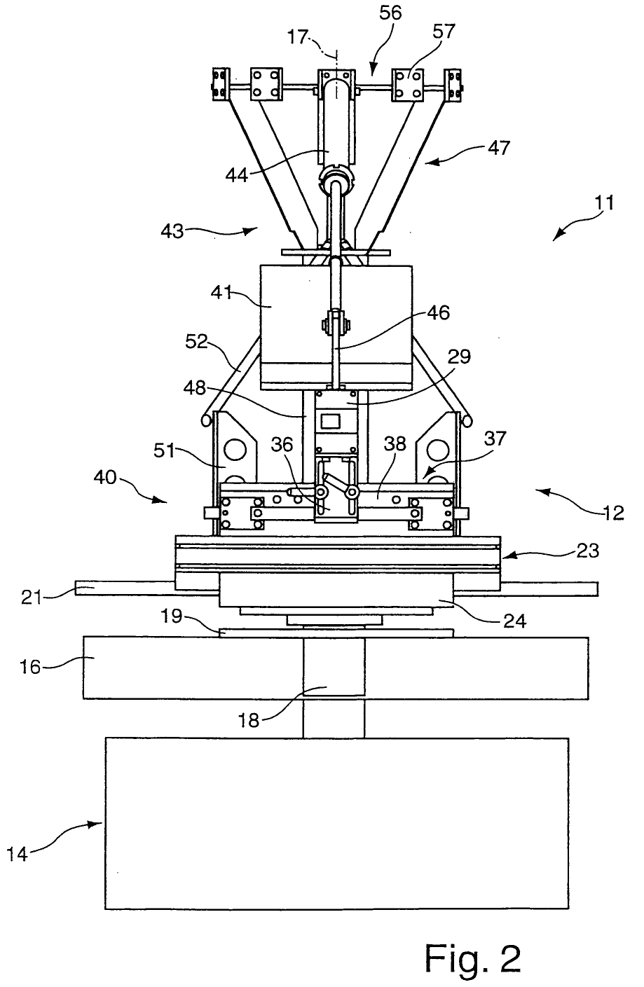

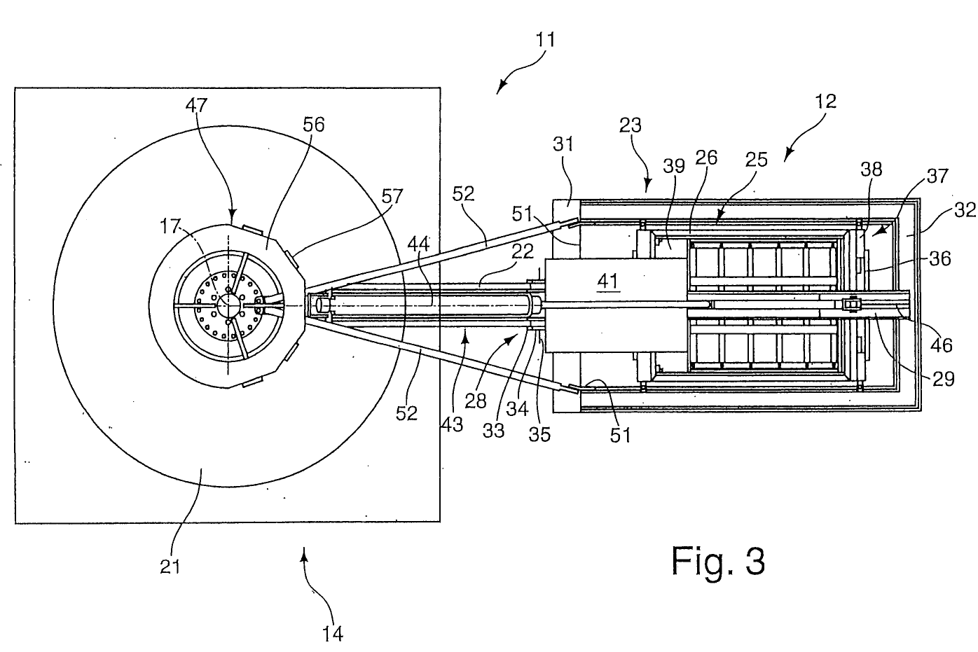

FIGS. 1 to 5 show diagrammatic views of an apparatus 11 for the flocking of articles, only one processing station 12 being illustrated for the sake of clarity. This apparatus 11 comprises a central column 14 in which a drive, not illustrated in any more detail, is arranged. This drive is preferably designed as a servo drive. Alternatively, an indexing turntable may also be used. The drive drives a revolving stage 16, arranged on the central column 14, for example via a gearwheel mechanism or via a toothed-belt drive which is mounted rotatably about a vertical axis 17. Pallet carriers 18 are arranged in the form of a star on the revolving stage 16 and in each case carry a pallet 19 at their free ends.

Above the revolving stage 16 is provided a baseplate 21, on which frame carriers 22 are provided in the form of a star in a similar way to the pallet carriers 18 and in each case carry a frame 23 at their free outer ends. The frame 23 has holding elements 24 which are preferably provided with quick-action clamping elements, not illustrated in any more detail, in order to receive a stencil frame 26 of a stencil 25 having a flocking design in a quickly exchangeable way.

After a rotational movement for transferring the pallet 19 into a working position below the frame 23, the central column 14 executes a lifting movement, in order to transfer the article carried on the pallet 19 into a working position with respect to the stencil frame 26. Alternatively, the frame may also be lowered with respect to the pallet carrier.

On the frame 23 is arranged a rotary bearing 28 which receives a carrying arm 29 pivotably. This rotary bearing 28 is provided on the frame carrier 22 or an inner frame portion 31 which is arranged near the vertical axis 17 or is offset inwards with respect to a radially outer frame portion 32. This rotary bearing 28 may be formed by a flange plate 33 in which a shaft 34 is mounted pivotably. This rotary bearing 28 therefore has an axis of rotation 35 which is oriented tangentially to the circular path along which the pallet carriers 18 are guided when a plurality of processing positions predetermined in steps are assumed. The carrying arm 29 preferably extends along the frame 23 as far as the outer frame portion 32. On an underside of the carrying arm 29, a holding device 36 is provided which receives a flocking device 37. This holding device 36 preferably likewise comprises quick-action clamping elements, so that the flocking device 27 can be mounted and demounted quickly. A rapid and simple change of the flocking devices 37 can thereby be achieved, in order, for example, to make it possible to use a differently coloured flock material and/or another flock length and/or another type of flock material.

The flocking device 37 comprises a flocking container 38 which is preferably formed from transparent material, in particular transparent plastic. An electrically conductive fabric for the outlet of the flock material is provided on an underside of the flocking container 38. In the flocking container 38, one or more applicator elements, in particular applicator brushes, are assigned to the fabric 39 and can be moved to and fro above the fabric 39. Furthermore, in the flocking container 38, an electrode is provided which charges the flock material electrostatically for the expulsion of the latter.

Above the frame 23, a control unit 41 for the flocking device 37 is provided, in order to apply a high voltage during flocking and supply the electrode.

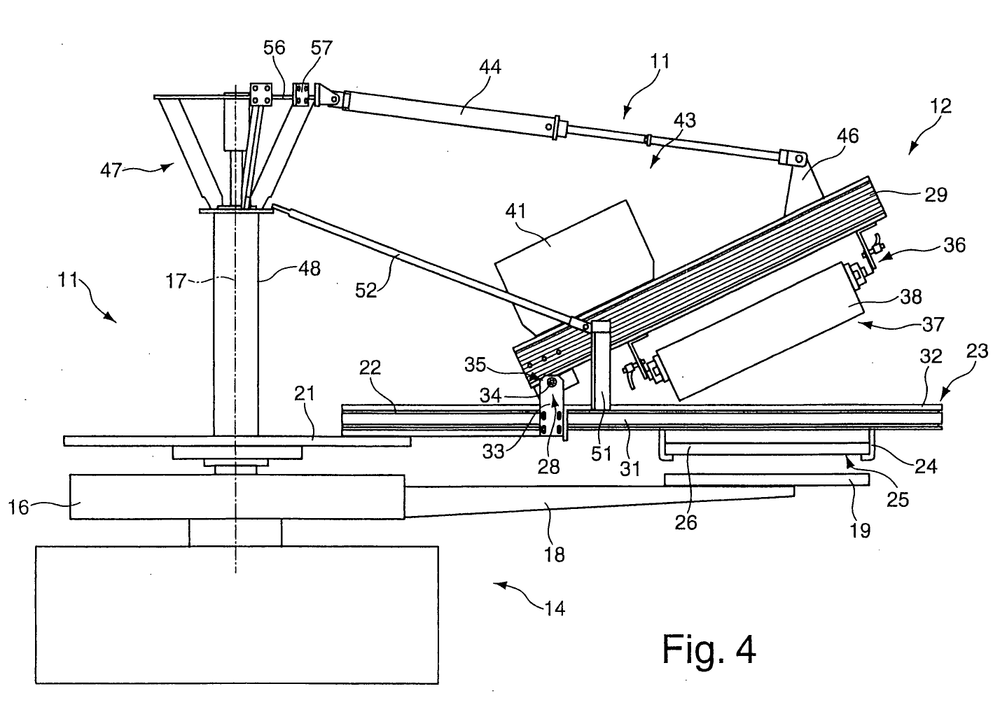

This processing station 12 comprises, further, an actuating device 43, in order to pivot the carrying arm 29 upwards about the axis of rotation 35, as illustrated in FIG. 4. The actuating device 43 comprises at least one working cylinder 44 which can be activated pneumatically. Alternatively, the working cylinder may be activatable both hydraulically and electrically. This working cylinder 44 acts on a flange plate 46 which is arranged on the carrying arm 29 in a radially outer region. On the opposite side, the working cylinder 44 acts on an articulation device 47 which is fastened to a lifting pillar 48 of the apparatus 11. On the carrying arm 29, an actuating element 49 is provided, by means of which an up-and-down movement of the flocking device 37 is started. Alternatively, there may be provision for this actuating element 49 to be arranged on one end face of the outer frame portion 32, so that good access, outside a working range of the pallet carrier 18, is made possible for attendance. An articulation point of the working cylinder 44 at the flange plate 46 is raised with respect to the carrying arm 29, so that the control device 41 can likewise be arranged on the carrying arm 29 in a visually easily observable position.

The frame carrier 22 or the frame 23 comprises a supporting element 51 or a supporting angle 51 which in each case engage on or near the inner frame portion 31, these supporting elements being connected to an upper end of the lifting pillar 48 by means of struts 52, so that such a framework makes it possible to have a stable and rigid arrangement of the frame 23 with respect to the central column 14 of the apparatus 11. Furthermore, arranging the working cylinder 44 above the struts 52 makes it possible to generate a counterforce via the struts 52 during a lifting-off or lowering movement of the flocking device 47, so that a distortion-resistant and inherently stable arrangement is provided.

The articulation device 47, which may preferably likewise be a component of the actuating device 43, comprises a peripheral ring 56, on which a plurality of mounting plates 57 are arranged, in order to fasten the working cylinders 44 to them. Preferably, each mounting plate 57 is assigned to a processing station 12. This articulation device 47 is arranged above the lifting pillar 48. The previous set-up of a processing station can thereby, in principle, be preserved.

FIG. 1 illustrates only one processing station 12 of an apparatus for the flocking of articles, in particular textile materials. Such apparatuses 11, may be equipped with a multiplicity of processing stations 12, so that multi-coloured flocking is made possible. To carry out such multi-coloured flocking, a first processing station 12 is designed as a printing station and serves for applying an adhesive to the article. For this purpose, a doctor blade is provided on the carrying arm, in order, according to the flocking design to be applied, to apply an adhesive via the stencil to the article to be finished or to be flocked.

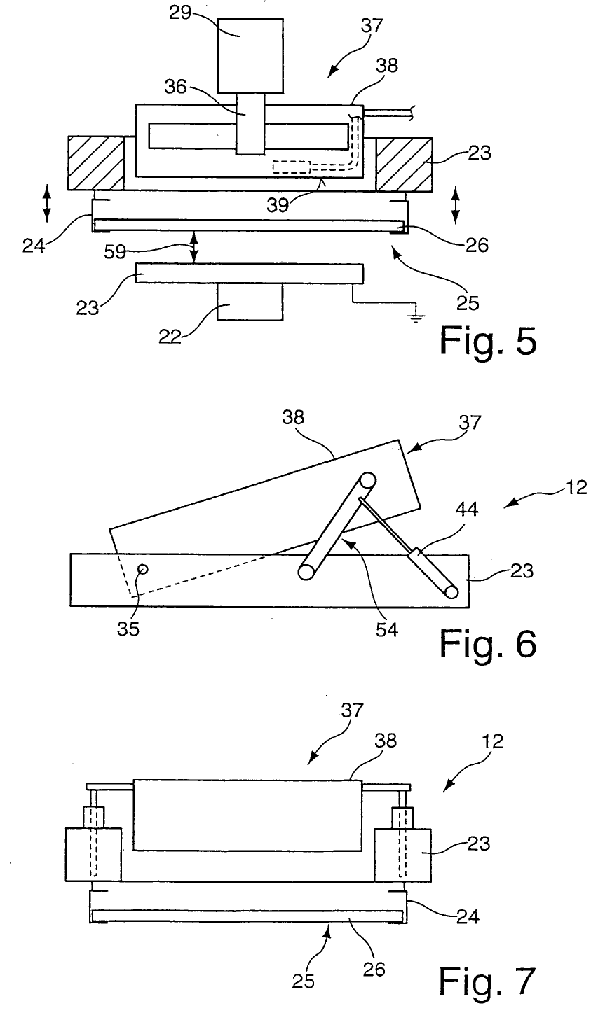

After adhesive has been applied to the article, the pallet 19 is lowered by means of the central column 14. The pallet 19 is clocked on into the next rotary position and is subsequently raised again. In this following processing station 12, a first flocking material is applied to the article. For this purpose, a high voltage is applied in the flocking container 38 and the applicator brushes are moved to and fro. The article is provided at a defined and exactly set distance 59 from the stencil frame 26 (FIG. 5), so that a breakdown of the high voltage to the article is avoided. In order to make this exact setting possible, the holding elements 24 can be set in terms of height in relation to the frame 23. In addition, the distance between the lower outlet side of the flocking container 38 and the stencil 25 can be set, so that optimal processing conditions for applying the flock material to the article are afforded.

After the flock material has been applied in the first processing station 12, the partially flocked article is clocked on to a second processing station 12. A further flock material is applied in this processing station 12. This further flocking material may have a different fibre length, colour and/or type of material. Subsequently, as a function of the selected flocking design, one or more further processing stations 12 may be provided. After the completion of the flocking design, a processing station 12 is formed as a drying unit. Following this, a processing station 12 is provided in order to extract the flocked article from the pallet 19.

In the case of flocking designs with a plurality of processing steps because of the use of different colours, fibre lengths or flocking materials, it is necessary that the stencils must in each case be coordinated with one another, so that the part-designs can be applied exactly in order to ensure exact transitions of the individual flocking regions consisting of different flocking materials or colours. So that the setting of the stencil frame 26 or of the setting marks arranged on the stencil is made possible in a simple way, the flocking container 37 must be lifted off with respect to the frame 23, so that the setting mark on the stencil is visible. This setting mark must be set congruently to a setting mark of the stencil which is provided in the first processing station 12. Such setting operations usually have to be carried out several times for the exact set-up of a new flocking design, and therefore it is necessary for the flocking device 37 to be lifted off several times. By the actuating device 37 being configured according to the invention, simple handling is made possible. The upward pivoting of the flocking device 37 about the axis of rotation 35 affords rapid and easy access. At the same time, the flexibility of the apparatus 11 is maintained, since the flocking device 37 is received on the carrying arm 39 via the holding device 36 so as to be exchangeable in a simple way. The actuating device 37 can also make it easier to set up a flocking design by means of only one flocking operation in coordination with the application of an adhesive layer.

In so far as a flocking device 37 is not required in the processing station 12 in the case of a flocking design to be newly set up there may preferably be provision, further, for applying a magnetic foil to the fabric 39 on the flocking container 38, so that the flocking container 38 is closed from below and can remain in the processing station 12, without soiling occurring during the step-by-step clocking-on of the pallets 19 into the predetermined rotary positions by means of the central column 14. In so far as the processing station 12 is to be used again, such a magnetic foil is removed.

An alternative embodiment to the actuating device 37 illustrated in FIGS. 1 to 5 is afforded in that the flocking container 37 itself has a shaft 34 which is received, for example, by a flange plate 33. The working cylinder 44 can act on the flocking container 38 directly or via a further flange plate 36. The statements relating to FIGS. 1 to 5 otherwise apply.

An alternative embodiment of the actuating device 43 is provided in FIG. 6. In this embodiment, the flocking container 37 is mounted directly on the frame 23 pivotably via an axis of rotation 35. A working cylinder 44 acts, on the one hand, on the frame 23 and, on the other hand, on the flocking container 38, with the result that a pivoting movement is likewise achieved, so that the flocking container 38 can be lifted off upwards and the stencil frame 26 is accessible from a region outside the working range of the pallet carrier 22. Furthermore, there may be provision for a lever mechanism 54 to be provided on the frame 21 and the flocking container 38, in order to increase the pivoting movement and/or to reduce the forces, so that a smaller working cylinder can be employed.

A further alternative embodiment of an actuating device 43 is provided in FIG. 7. This actuating device 43 comprises, for example, two lifting cylinders which are arranged in each case on the frame 23. The lifting cylinders act on the flocking container 38 and, for example, execute a lifting movement during which the flocking container 38 is lifted off upwards, parallel to the stencil. Alternatively, a pivoting movement may also be carried out, in so far as the flocking container 38 is provided pivotably on the frame 23 in a similar way to the embodiment in FIGS. 1 to 5. In such an embodiment, the lifting cylinders are preferably arranged pivotably on the frame 23.

By raising and lowering the flocking container 38 in parallel, if two lifting cylinders lying opposite one another are used, a guide is preferably provided additionally, arranged parallel to these, in order to prevent tilting. Alternatively, instead of the additional at least one guide or even additionally, at least one further lifting cylinder may also be provided. So that a sufficient lift for lifting off the flocking container 38 with respect to the frame 23 is made possible, the lifting cylinders are preferably designed telescopically.

What is claimed is:

1. Apparatus for the flocking of articles, in particular textile materials, mats, ceramics, plastics, paper, wood or metal,
with a central column which has a rotary drive rotating about a vertical axis,
with a least one pallet carrier arranged on the central column and having in each case a pallet, arranged on the pallet carrier, for receiving an article to be flocked,
with at least one frame carrier, arranged above the pallets revolving around the vertical axis, for receiving a flocking device, the frame carrier and a frame arranged on it and also the pallet being arranged so as to be moveable in the vertical direction in relation to one another, and the pallet carrier on the central column assuming a plurality of rotary positions predetermined in steps along a circular path with respect to the frame,
characterized
in that a mechanical actuating device is provided, which lifts off the flocking device at least partially from the frame, so that a stencil arranged on the frame is accessible.

2. Apparatus according to claim 1, characterized in that the flocking device is mounted pivotably about an axis of rotation which is provided between an outer frame portion of the frame part and a vertical axis, so that the flocking device is pivotable upwards in the direction of the vertical axis.

3. Apparatus according to claim 1, characterized in that the flocking device is arranged pivotably about an axis of rotation provided on the frame, and the axis of rotation is oriented tangentially to the circular path, so that the flocking device is liftable off upwards in the direction of the vertical axis.

4. Apparatus according to claim 1, characterized in that, on the frame or frame carrier, a carrying arm pivotable about an axis of rotation is provided, on which the flocking device is arranged, and the axis of rotation is oriented tangentially to the circular path, so that the flocking device can be lifted off upwards in the direction of the vertical axis.

5. Apparatus according to claim 4, characterized in that the flocking device is fastened releasably to the carrying arm.

6. Apparatus according to claim 1, characterized in that the actuating device comprises at least one working cylinder which acts on a region, outer radially to the axis of rotation, on the flocking device or on the carrying arm receiving the flocking device and which, on the opposite side, is fastened to an articulation device which is arranged on a lifting pillar of the central column.

7. Apparatus according to claim 6, characterized in that the articulation device has a ring designed concentrically to the vertical axis and having a plurality of mounting plates for arranging the working cylinders.

8. Apparatus according to claim 4, characterized in that the carrying arm receiving the flocking device or the flocking device arranged pivotably on the frame are pivotable upwards out of a working position about the axis of rotation through at least 15°.

9. Apparatus according to claim 1, characterized in that the actuating device has at least one working cylinder which acts on the frame and on the flocking device or on a carrying arm receiving the flocking device and which pivots the flocking device upwards about the axis of rotation in the direction of the vertical axis.

10. Apparatus according to claim 9, characterized in that, between the frame and the flocking device or the carrying arm receiving the flocking device, a lever mechanism is provided, on which at least one working cylinder articulated on the frame acts.

11. Apparatus according to claim 1, characterized in that the actuating device has at least two lifting cylinders which are arranged on the frame and which lift off the flocking device upwards with respect to the frame and parallel to the latter.

12. Apparatus according to claim 11, characterized in that the actuating device has, running parallel to the lifting movement, at least one guide for aligning the flocking device.

13. Apparatus according to claim 11, characterized in that four lifting cylinders are provided, which are arranged in or near each corner region on the frame and which simultaneously initiate a lifting movement on the flocking device.

14. Apparatus according to claim 11, characterized in that the lifting cylinders of the actuating device are telescopic.
